(19) United States
(12) Patent Application Publication
(10) Pub. No.: US 2016/0216785 A1
(43) Pub. Date: Jul. 28, 2016

(54) Stylus and Button Pressing Aid

(71) Applicant: Joshua K. Smith, Richmond, VA (US)

(72) Inventor: Joshua K. Smith, Richmond, VA (US)

(21) Appl. No.: 14/989,331

(22) Filed: Jan. 6, 2016

Related U.S. Application Data
(60) Provisional application No. 62/107,877, filed on Jan. 26, 2015.

(51) Int. Cl. G06F 3/0354

(52) U.S. Cl. CPC G06F 3/03545

(57) ABSTRACT

An apparatus used for pressing keys on a keyboard, scrolling through a touch sensitive screen, or handling a work tool contains a structural body and a tip accessory. The structural body further contains a size adjustable ring and a protruding arm. The size adjustable ring is worn by an individual with limited hand function. When worn, the protruding arm extends outwards from the size adjustable ring. Upon wearing the size adjustable ring, the protruding arm and the tip accessory which is attached to the protruding arm is directed towards the keyboard, the touch sensitive screen or other receiving surface. Depending on user preference, the tip accessory can be a stylus tip, a screw driver head, or a knife.

The current application claims a priority to the U.S. Provisional Patent application Ser. No. 62/107,877 filed on Jan. 26, 2015.

### FIELD OF THE INVENTION

The present invention relates generally to an apparatus that can be used by individuals with limited hand function. More specifically, the present invention is intended to be used by individuals with limited hand function to push buttons, use a keyboard, or use a touch screen enabled device.

### BACKGROUND OF THE INVENTION

Humans and other animals use fingers for gripping, grasping, and controlling purposes. In order to successfully control or grasp an object, each of the fingers need to work in coordination with each other. When at least one of the fingers has a hindrance, the overall coordination is affected. Many factors can lead to a user not being able to use the fingers to its full potential.

Accidents to fingers are one of the main causes that limits a user from successfully using a keyboard or any other portable computing device. As an example, firework accidents, car accidents, ring avulsion injuries or any other injury that harms the fingers can impede the use of a portable computing device. The inability is not only a setback to the mental state of an injured person, but also affects the overall productivity of the injured person.

Certain conditions such as finger paralysis can also hinder the ability to control the keyboard and the touch screen. Finger paralysis can be caused by medical conditions such as diabetes, peripheral artery disease, and carpel tunnel syndrome. When considering carpel tunnel syndrome, it can be caused by repetitive, strenuous actions which involves jarring of the hands such as keyboarding. For an individual recovering from carpel tunnel syndrome or a related medical condition, using a regular keyboard can reduce the rate of progress. Therefore, the need for an apparatus that can be used for keyboarding is clearly evident.

In addition to hindering the ability to control a portable computing device, accidents and other medical conditions also limit the user from engaging in routine activities. As an example, activities such as writing and handling a tool can be affected due to the conditions prevalent in the fingers or related muscles and organs. Since activities such as writing and handling a tool requires coordination between the fingers, the inability to use one or more fingers can have a huge impact on the ability to control a pen or a tool.

The objective of the present invention is to address the aforementioned issues. In particular, the present invention introduces an apparatus that can be used by individuals with limited hand function for pressing keys on the keyboard or navigating a touch screen. Additionally, the effective design of the present invention also allows the user to attach a tool, a pen or any other comparable device with convenience by using the threaded tip. By utilizing the present invention, individuals with injured fingers or other related medical conditions can overcome many difficulties encountered on a daily basis.

### BRIEF DESCRIPTION OF THE DRAWINGS

FIG. 1 is a perspective view of the present invention.

FIG. 2 is an exploded view of the present invention.

FIG. 3 is a top view of the structural body, wherein the arc-shaped gap is expanded.

FIG. 4 is a top view of the structural body, wherein the arc-shaped gap is compressed.

FIG. 5 is a perspective view of the tip accessory.

FIG. 6 is a perspective view of the present invention, wherein the protruding arm is length adjustable.

FIG. 7 is a perspective view of another embodiment of the structural body.

### DETAIL DESCRIPTIONS OF THE INVENTION

All illustrations of the drawings are for the purpose of describing selected versions of the present invention and are not intended to limit the scope of the present invention.

The present invention is intended to be used as an aid when controlling a keyboard or a touch screen. However, the effective design also allows the user to apply the present invention for handling tools and other comparable activities.

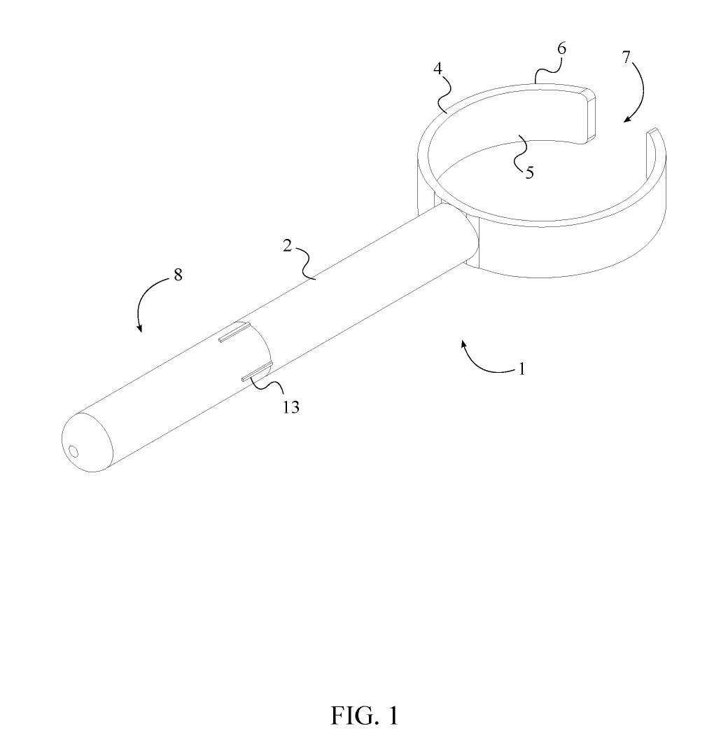

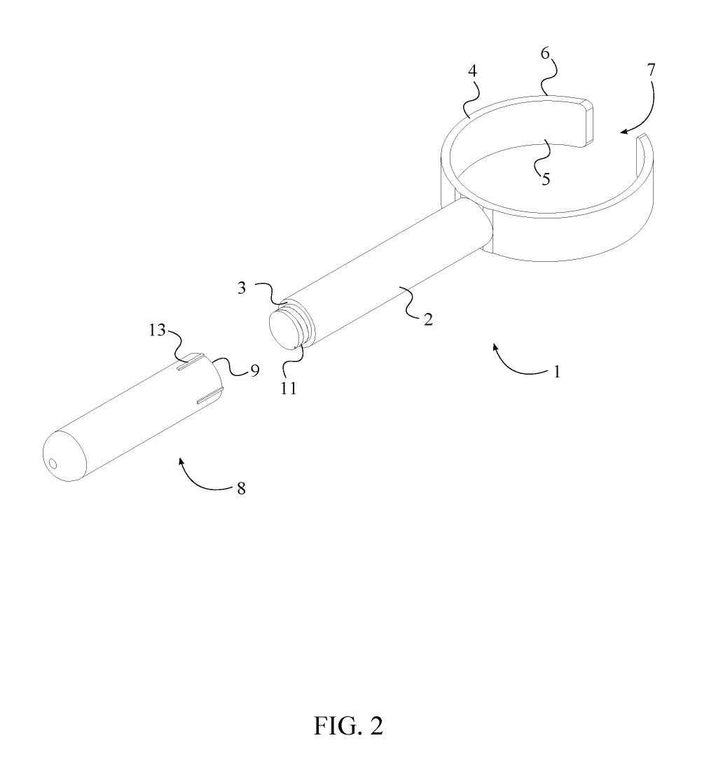

The present invention comprises a structural body 1 and a tip accessory 8 as illustrated in FIG. 1 and FIG. 2. The structural body 1 allows the present invention to be worn by the user. On the other hand, the tip accessory 8 is used to make contact with a keyboard, a touch sensitive screen, or any other corresponding surface the present invention is being used with. In order to use the present invention with multiple receiving surfaces, the tip accessory 8 is removably attached to the structural body 1 through an attachment mechanism 10. Therefore, the tip accessory 8 can be conveniently switched as preferred.

The structural body 1 comprises a protruding arm 2 and a size adjustable ring 4. In order to wear the present invention as mentioned before, the user utilizes the size adjustable ring 4. More specifically, the size adjustable ring 4 is worn on a finger of the user. The size adjustable ring 4 is adjacently connected to the protruding arm 2. As a result, when the size adjustable ring 4 is worn on the finger, the protruding arm 2 extends outwards from the finger. The adjacent connection allows the user to control the position of the protruding arm 2 with the finger. The tip accessory 8 is adjacently attached to the protruding arm 2 by the attachment mechanism 10 opposite the size adjustable ring 4. The adjacent attachment allows the tip accessory 8 to be controlled with the finger wearing the size adjustable ring 4. Moreover, the protruding arm 2 is radially oriented with a center 100 of the size adjustable ring 4 allowing the user to apply a maximum amount of force through the protruding arm 2. For user convenience, the structural body 1 is made of a lightweight material. In the preferred embodiment of the present invention, the structural body 1 is made of aluminum. However, other comparable lightweight material can be used in different embodiments of the present invention.

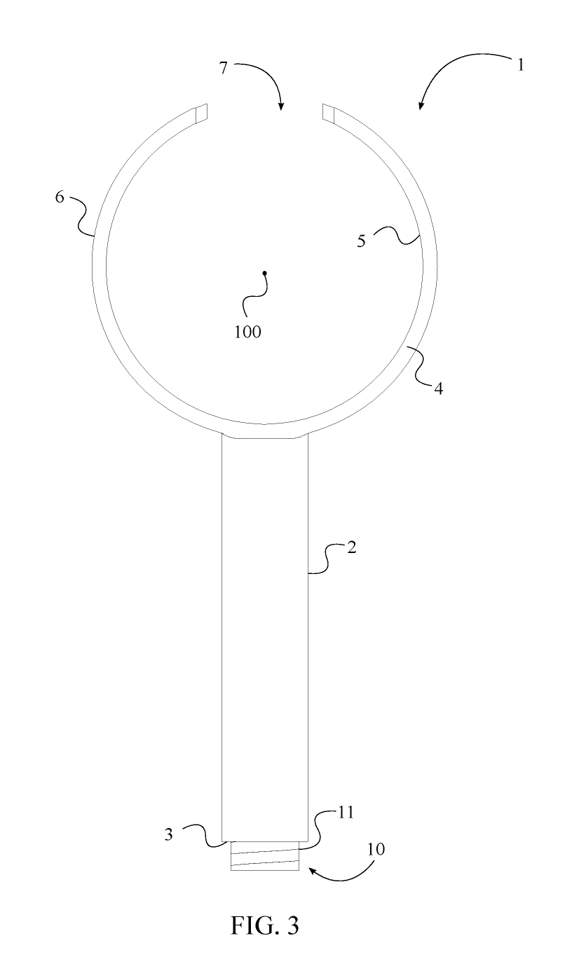

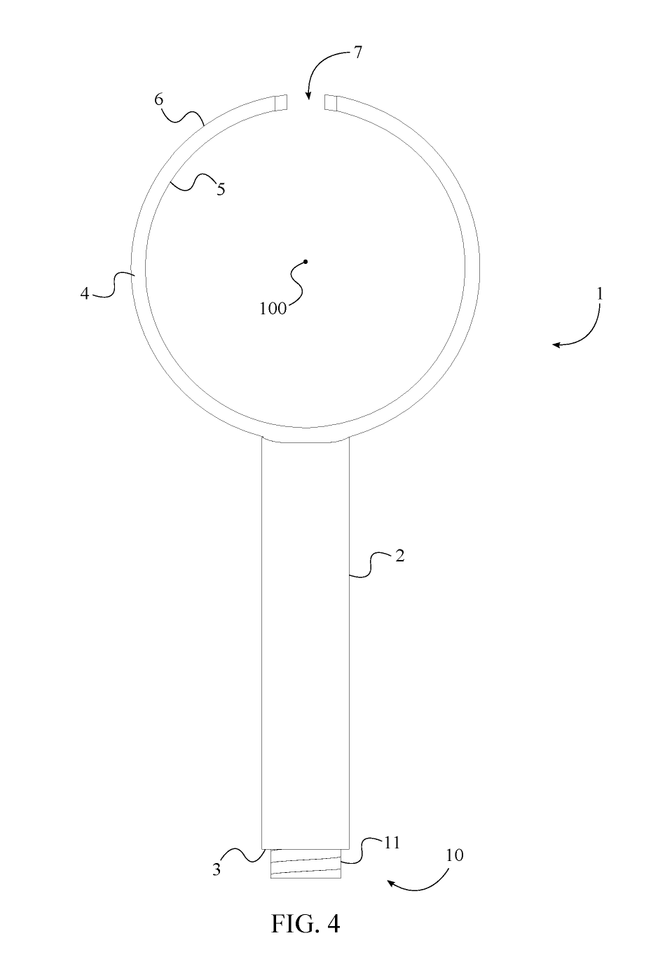

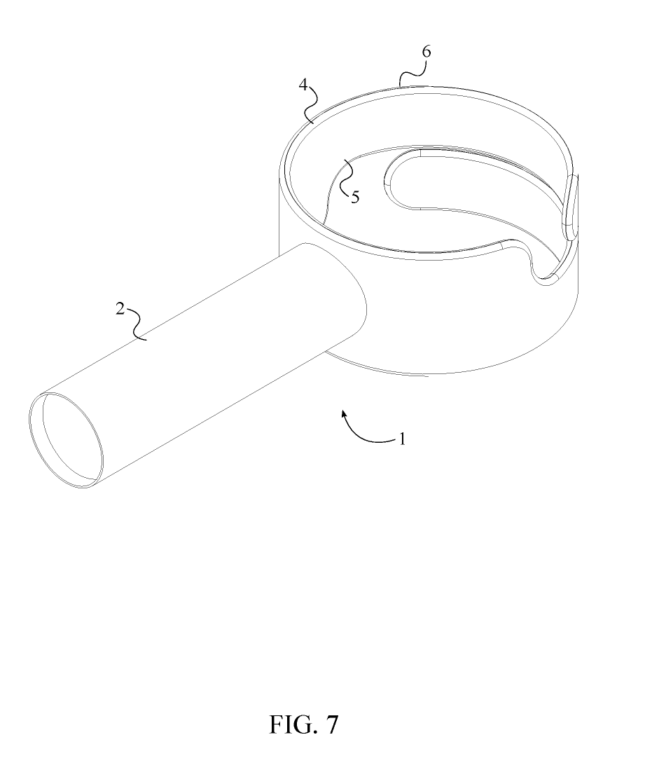

The size adjustable ring 4 allows users with different finger sizes to utilize the present invention. In the preferred embodiment of the present invention, an arc-shaped gap 7 is used for size adjusting purposes. However, as illustrated in FIG. 7, other comparable size adjusting methods can also be used in other embodiments of the present invention. The size adjustable ring 4 comprises an inner surface 5 and an outer surface 6. When the size adjustable ring 4 is worn, the inner surface 5 is in contact with the finger of the user. The arc-shaped gap 7 traverses through the size adjustable ring 4 from the inner surface 5 to the outer surface 6. If the user intends on tightening the size-adjustable ring, the arc-shaped gap 7 is compressed as illustrated in FIG. 4. On the other hand, if the user intends on loosening the size-adjustable ring, the arc-shaped gap 7 is expanded as shown in FIG. 3. By adjusting the arc-shaped gap 7 accordingly, the user ensures that the size adjustable ring 4 snugly fits around the finger. A firm and comfortable fit is essential in order to have proper control of the tip accessory 8 attached to the protruding arm 2.

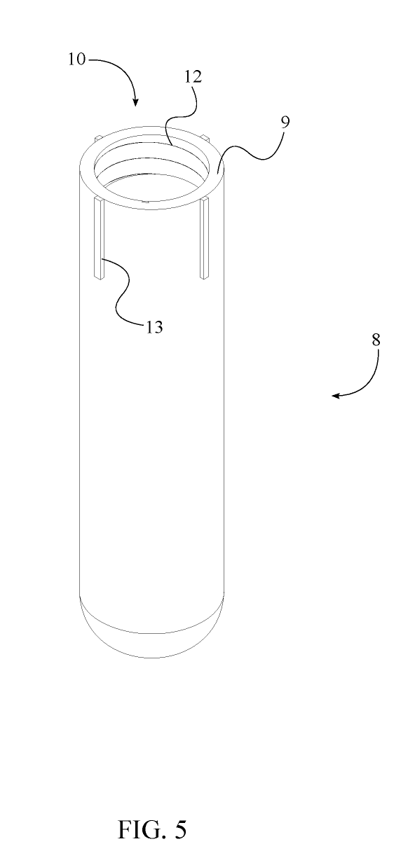

As previously mentioned, the tip accessory 8 is removably attached to the structural body 1 through the attachment mechanism 10. In the preferred embodiment of the present invention, the attachment mechanism 10 comprises a first plurality of threads 11 and a second plurality of threads 12. However, the attachment mechanism 10 can vary in different embodiments of the present invention. As seen in FIG. 2, the first plurality of threads 11 is integrated about a distal end 3 of the protruding arm 2. On the other hand, the second plurality of threads 12 is integrated about a base end 9 of the tip accessory 8 as seen in FIG. 5. When the tip accessory 8 is adjacently attached to the protruding arm 2 in the preferred embodiment of the present invention, the first plurality of threads 11 is engaged with the second plurality of threads 12.

In order to provide user convenience when removing or attaching the tip accessory 8, the present invention comprises a plurality of gripping features 13. The plurality of gripping features 13 is integrated about the tip accessory 8 and adjacent the second plurality of threads 12. When the user holds the tip accessory 8, the plurality of gripping features 13 allows the user to maintain a firm connection with the tip accessory 8. Moreover, the positioning of the plurality of gripping features 13 allows the user to conveniently secure the tip accessory 8 to the distal end 3.

As previously mentioned, the tip accessory 8 can change according to user preference. If the user intends on using a keyboard or controlling a touch sensitive screen, a stylus tip is used as the tip accessory 8. In another instance, if the user intends on using the present invention for writing purposes, a pen is used as the tip accessory 8. The effective design of the present invention also allows a work tool to be attached as the tip accessory 8. As an example, a screw driver head or a knife can be attached as the tip accessory 8 in another case of using the present invention. Regardless of the type of the tip accessory 8, the attachment mechanism 10 is used when attaching the tip accessory 8 to the protruding arm 2.

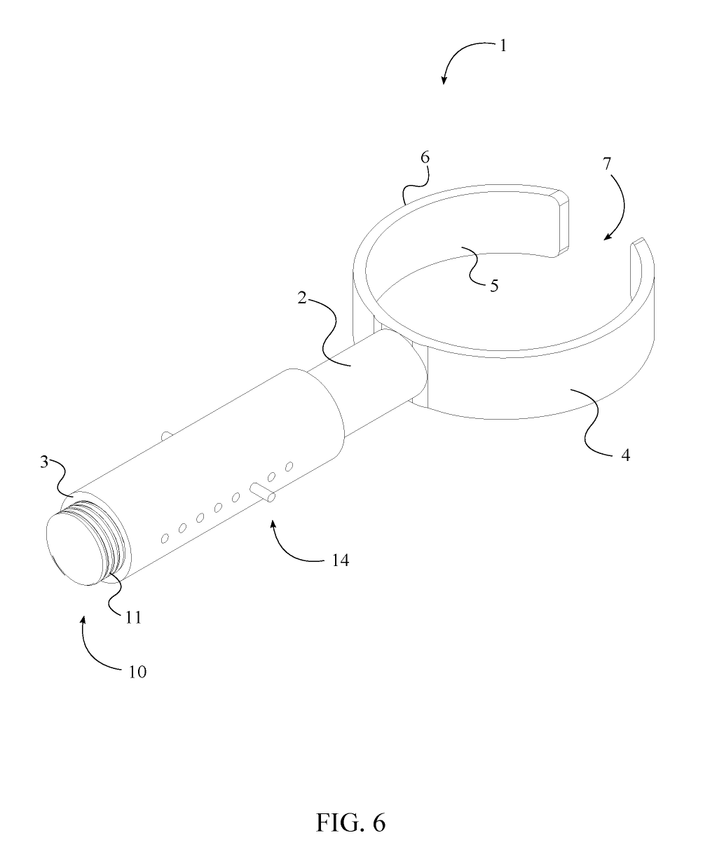

The force used to successfully operate the present invention can vary according to the tip accessory 8. To allow the user to apply force differently, the protruding arm 2 can be length adjustable in another embodiment of the present invention. As an example, the protruding arm 2 can be made shorter if the tip accessory 8 is the work tool. On the other hand, the protruding arm 2 can be made longer if the tip accessory 8 is used for pressing buttons on the keyboard. As illustrated in FIG. 6, different mechanisms can be used to make the protruding arm 2 length adjustable. As an example, a telescopic mechanism 14 can be mechanically integrated into the protruding arm 2. Even though the telescopic mechanism 14 is mentioned in this example, other comparable length adjustable methods can be utilized in other embodiments of the present invention.

When utilizing the present invention, the following process flow is generally followed. As an initial step, the tip accessory 8 is selected according to user preference. As mentioned earlier, the tip accessory 8 can be the stylus tip, the pen, the work tool or any other comparable accessory. Afterwards, the tip accessory 8 is attached to the protruding arm 2 through the attachment mechanism 10. In the preferred embodiment of the present invention, the tip accessory 8 is attached by using the first plurality of threads 11 and the second plurality of threads 12. When the tip accessory 8 is secure, the user proceeds to wear the present invention on the finger. In doing so, the user positions the finger within the size adjustable ring 4 and adjusts the size adjustable ring 4 accordingly. In its final configuration, the size adjustable ring 4 snugly fits around the finger of the user. When the user establishes a firm connection with the present invention, the user proceeds to direct the protruding arm 2 and the tip accessory 8 which is attached to the protruding arm 2 in the direction of the receiving surface. Depending on the tip accessory 8, the receiving surface can be the keyboard, the touch sensitive screen, or any other corresponding surface.

Although the invention has been explained in relation to its preferred embodiment, it is to be understood that many other possible modifications and variations can be made without departing from the spirit and scope of the invention as hereinafter claimed.

What is claimed is:

1. An apparatus for pressing keys on a keyboard and controlling a touch sensitive screen comprises:
a structural body;
a tip accessory;
an attachment mechanism;
the structural body comprises a protruding arm and a size adjustable ring;
the size adjustable ring being adjacently connected to the protruding arm;
the tip accessory being adjacently attached to the protruding arm by the attachment mechanism, opposite the size adjustable ring; and
the protruding arm radially oriented with a center of the size adjustable ring.

2. The apparatus for pressing keys on a keyboard and controlling a touch sensitive screen as claimed in claim 1 comprises:
an arc-shaped gap;
the size adjustable ring comprises an inner surface and an outer surface; and
the arc-shaped gap traversing through the size adjustable ring from the inner surface to the outer surface.

3. The apparatus for pressing keys on a keyboard and controlling a touch sensitive screen as claimed in claim 1 comprises:
the attachment mechanism comprises a first plurality of threads and a second plurality of threads;
the first plurality of threads being integrated about a distal end of the protruding arm;
the second plurality of threads being integrated about a base end of the tip accessory; and
the first plurality of threads being engaged with the second plurality of threads.

4. The apparatus for pressing keys on a keyboard and controlling a touch sensitive screen as claimed in claim 3 comprises:
a plurality of gripping features; and
the plurality of gripping features being integrated about the tip accessory, adjacent to the second plurality of threads.

5. The method for pressing keys on a keyboard and controlling a touch sensitive screen as claimed in claim 1, wherein the tip accessory is a stylus tip.

6. The method for pressing keys on a keyboard and controlling a touch sensitive screen as claimed in claim 1, wherein the tip accessory is a pen.

7. The method for pressing keys on a keyboard and controlling a touch sensitive screen as claimed in claim 1, wherein the tip accessory is a work tool.

8. The apparatus for pressing keys on a keyboard and controlling a touch sensitive screen as claimed in claim 1 wherein, the protruding arm is length adjustable.

9. The apparatus for pressing keys on a keyboard and controlling a touch sensitive screen as claimed in claim 1 wherein, a telescopic mechanism is mechanically integrated into the protruding arm.

10. The method for pressing keys on a keyboard and controlling a touch sensitive screen as claimed in claim 1, wherein the structural body is made of aluminum.
